(19) United States
(12) Patent Application Publication
(10) Pub. No.: US 2013/0004645 A1
(43) Pub. Date: Jan. 3, 2013

(54) SWEET ONION SAUCE AND METHOD OF MANUFACTURING SAME

(76) Inventor: JOSEPH PAGLINO, Allentown, NJ (US)

(21) Appl. No.: 13/539,283

(22) Filed: Jun. 29, 2012

Related U.S. Application Data
(60) Provisional application No. 61/503,073, filed on Jun. 30, 2011.

(51) Int. Cl. A23L 1/39

(52) U.S. Cl. 426/589

(57) ABSTRACT

Embodiments of the present invention are generally related to a sweet onion sauce and methods of manufacturing the same. More specifically, embodiments of the present invention relate to a sweet onion sauce having an improved flavor resulting from natural and healthy ingredients, and methods of manufacturing the same for commercial purposes. In one embodiment of the present invention, a consumable composition consists of: a plurality of onions; water; maple syrup; tomato paste; olive oil; balsamic vinegar; and one of either cayenne pepper, hickory seasoning or hot sauce.

### CROSS-REFERENCE TO RELATED APPLICATIONS

This application claims priority to U.S. Provisional Patent Application Ser. No. 61/503,073, filed Jun. 30, 2011, and titled “Sweet Onion Sauce and Method of Manufacturing Same,” the disclosure of which is incorporated herein by reference in its entirety.

### BACKGROUND

1. Field of the Invention

Embodiments of the present invention are generally related to a sweet onion sauce and methods of manufacturing the same. More specifically, embodiments of the present invention relate to a sweet onion sauce having an improved flavor resulting from natural and healthy ingredients, and methods of manufacturing the same for commercial purposes.

2. Description of the Related Art

Human health habits and taste preferences evolve over time, as evidenced by comparing supermarket shelves from decades ago with today's food selection. Much of this change can be blamed on scientists learning more about the effects of various food items on our health. As a result, the past decade has witnessed an evolutionary change back to bringing more organic and natural food products into everyday diets.

One particular genre of food that has not seen as much change as others is the condiment and sauce industry. While few companies have come out with “organic” ketchups, mustards, salad dressings, tomato sauces, etc., much of the industry remains unchanged from the chemically-based food products of the past. It is believed the lack of change in this particular industry is largely due to the prevalence of the naturalness of the primary food upon which the condiment would be placed.

As far as commercially available sweet onion sauces, very few exist in the marketplace. The most well-known of all commercially available sweet onion sauces is manufactured by Marathon Enterprises, Inc., of Englewood, N.J., under the brand SABRETT®. While SABRETT sweet onion sauce does very well commercially, due to its frequent packaging with a more potent hot dog, its ingredients are largely unnatural and include a significant number of chemicals (i.e., preservatives, etc.), which lead to an undesirable flavor.

Thus, there is a need for an improved sweet onion sauce and a method for manufacturing the same.

### SUMMARY

Embodiments of the present invention are generally related to a sweet onion sauce and methods of manufacturing the same. More specifically, embodiments of the present invention relate to a sweet onion sauce having an improved flavor resulting from natural and healthy ingredients, and methods of manufacturing the same for commercial purposes.

In one embodiment of the present invention, a consumable composition consists essentially of: a plurality of onions; water; maple syrup; tomato paste; olive oil; and balsamic vinegar.

In another embodiment of the present invention, a consumable composition consists of: a plurality of onions; water; maple syrup; tomato paste; olive oil; balsamic vinegar; and one of either cayenne pepper, hickory seasoning or hot sauce.

In yet another embodiment of the present invention, a method of preparing a consumable composition, comprising the following steps conducted in the order listed: cutting off an outer layer of an onion, as well as the ends thereof; cutting onion widthwise into rings; mixing onion rings with olive oil and water in a pot; placing the pot on a stovetop set to low heat to simmer the contents therein; removing the pot from the stovetop and adding balsamic vinegar, maple syrup and tomato paste to the pot, and mixing the contents together; returning the pot to the stovetop set to low heat to simmer the contents therein; and removing the pot from the stovetop.

### DETAILED DESCRIPTION

Embodiments of the present invention are generally related to a sweet onion sauce and methods of manufacturing the same. More specifically, embodiments of the present invention relate to a sweet onion sauce having an improved flavor resulting from natural and healthy ingredients, and methods of manufacturing the same for commercial purposes.

In many embodiments of the present invention, in its basic form, the sweet onion sauce comprises a plurality of onions, water, a sugar-based syrup, tomato paste, oil, and vinegar. Alternatively, in certain embodiments, additional ingredients such as: cayenne pepper, hickory seasoning (e.g., Wright's Liquid Smoke), hot sauce, peppers, combinations thereof, or the like, may also be provided.

In one embodiment of the present invention, the sweet onion sauce comprises organic onions (i.e., grown with minimal interference from chemicals, pesticides, etc.). Although any type of onion may be used, many embodiments of the present invention incorporate Vidalia onions therein. Similarly, although any type of sugar-based syrup may be utilized with embodiments of the present invention, many embodiments comprise maple syrup. In one embodiment of the present invention, the sweet onion sauce comprises grade A, dark amber, maple syrup.

In some embodiments, any type of tomato paste may be utilized in the sweet onion sauce. However, in one embodiment, the tomato paste comprises the tomato paste manufactured and commercially sold by NINA brand, generally distributed out of San Marzano, Italy. Generally, the oil utilized in the sweet onion sauce may be any type of food oil suitable for embodiments of the present invention. In certain embodiments, the oil may comprise one of olive oil (e.g., Italian, extra virgin, olive oil), sesame oil, vegetable oil, or the like. Similarly, the vinegar may be any type of vinegar suitable for embodiments of the present invention, including, for example, balsamic vinegar (e.g., Italian balsamic vinegar de Modena), white vinegar or the like.

In some embodiments of the present invention, a sweet onion sauce may be made in a batch of about 80 ounces. In such an embodiment, the sweet onion sauce comprises: between about 2 to about 6 large onions, between about 1 to about 3 cups of water, between about ¼ to about ¾ cup maple syrup, and between about 3 to about 9 ounces of tomato paste, ¼ to ¾ cup of olive oil, between about ½ to about 1½ ounces of balsamic vinegar.

In one specific exemplary embodiment, to yield 80 ounces of sweet onion sauce, the sweet onion sauce consists of: 4 large Vidalia onions, 2 cups of water, ½ cup of maple syrup (grade A, dark amber), 6 ounces of tomato paste, ½ cup of extra virgin olive oil, and 1 ounce of balsamic vinegar.

In alternative embodiments of the present invention, the sweet onion sauce may additionally comprise: between about 1 to about 5 tbs. of hot pepper (e.g., cayenne pepper), between about 1 to about 5 tbs. of hickory seasoning (e.g., Wright's Liquid Smoke), between about 2 to about 10 tbs. of hot sauce (e.g., Louisiana Hot Sauce or pepper, vinegar and salt), combinations thereof, or the like. More specifically, in one embodiment of the present invention, the additional ingredients may comprise about 3 tbs. of hot pepper, about 3 tbs. of hickory seasoning, and/or about 6 tbs. of hot sauce.

In addition thereto, certain embodiments of the present invention may comprise nominal or minimal amounts of preservatives, which may be necessary for shelf life preservation. While any type of known preservative may be suitable for some embodiments of the present invention, certain embodiments of the present invention may seek to include all-natural preservatives therein. Exemplary preservatives include natural antimicrobial preservatives (e.g., grapefruit seed extract, germaben II, germaben II-E, liquid germall plus, liquapar oil, and the like), antioxidants (e.g., T-50 vitamin E oil, rosemary oil extract, or the like), and other known natural preservatives.

To manufacture a sweet onion sauce in accordance with embodiments of the present invention, the following method may be utilized. In one embodiment of the present invention, a method of manufacturing a sweet onion sauce comprises: (a) cutting off an outer layer of the onions, as well as the ends; (b) cutting the onions lengthwise into rings (e.g., between about ⅛ to about ½ an inch thick, or in one embodiment, ¼ inch thick); (c) place onions in a large pot with the olive oil and water, mixing them thoroughly; (d) covering the large pot and placing it on a stove burner on a low setting to simmer for between about 30 to about 60 minutes (note: in one embodiment, the contents of the pot should simmer for about 45 minutes); (e) after removing the pot from the heat, the remainder of the ingredients may be added to the pot, and stirred thoroughly; (f) the pot is placed back on the stove burner uncovered for between about 20 to about 40 minutes, and in one embodiment, about 30 minutes—stirring throughout; and (g) once the pot is removed from the heat, the contents should again be stirred thoroughly. Optionally, once step (g) is complete, the sweet onion sauce is either ready for consumption, canning, jarring, storage or the like.

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein. In addition, embodiments of the present invention are further scalable to allow for larger or smaller quantities, as particular applications may require.

What is claimed is:

1. A consumable composition consisting essentially of:
a plurality of onions;
water;
maple syrup;
tomato paste;
olive oil; and
balsamic vinegar.

2. The consumable composition of claim 1, wherein the onions are Vidalia onions.

3. The consumable composition of claim 1, wherein the maple syrup is grade A, dark amber maple syrup.

4. The consumable composition of claim 1, wherein the olive oil is extra virgin olive oil.

5. The consumable composition of claim 1, further consisting essentially of one of cayenne pepper, hickory sauce or hot sauce.

6. The consumable composition of claim 1, wherein the consumable composition is about 80 ounces.

7. The consumable composition of claim 6, wherein the consumable composition consists essentially of between about 2 to about 6 onions, between about 1 to about 3 cups of water, between about ¼ to about ¾ cup maple syrup, between about 3 to about 9 ounces of tomato paste, between about ¼ to ¾ cup of olive oil, and between about ½ to about 1½ ounces of balsamic vinegar.

8. The consumable composition of claim 7, wherein the consumable composition further consists essentially of between about 1 tbs. to about 5 tbs. of cayenne pepper, between about 1 tbs. to about 5 tbs. of hickory seasoning, or between about 2 tbs. to about 10 tbs. of hot sauce.

9. A consumable composition consisting of:
a plurality of onions;
water;
maple syrup;
tomato paste;
olive oil;
balsamic vinegar; and
one of either cayenne pepper, hickory seasoning or hot sauce.

10. The consumable composition of claim 9, wherein the onions are Vidalia onions.

11. The consumable composition of claim 9, wherein the maple syrup is grade A, dark amber maple syrup.

12. The consumable composition of claim 9, wherein the olive oil is extra virgin olive oil.

13. The consumable composition of claim 1, wherein the consumable composition is about 80 ounces.

14. The consumable composition of claim 13, wherein the consumable composition consists of between about 2 to about 6 onions, between about 1 to about 3 cups of water, between about ¼ to about ¾ cup maple syrup, between about 3 to about 9 ounces of tomato paste, between about ¼ to ¾ cup of olive oil, between about ½ to about 1½ ounces of balsamic vinegar, and one of between about 1 tbs. to about 5 tbs. of cayenne pepper, between about 1 tbs. to about 5 tbs. of hickory seasoning, or between about 2 tbs. to about 10 tbs. of hot sauce.

15. A method of preparing a consumable composition, comprising the following steps conducted in the order listed:
cutting off an outer layer of an onion, as well as the ends thereof;
cutting onion widthwise into rings;
mixing onion rings with olive oil and water in a pot;
placing the pot on a stovetop set to low heat to simmer the contents therein;
removing the pot from the stovetop and adding balsamic vinegar, maple syrup and tomato paste to the pot, and mixing the contents together;
returning the pot to the stovetop set to low heat to simmer the contents therein; and
removing the pot from the stovetop.

16. The method of claim 15, wherein adding balsamic vinegar, maple syrup and tomato paste to the pot further comprises adding one of either cayenne pepper, hickory seasoning or hot sauce.

17. The method of claim 15, wherein placing the pot on the stovetop set to low heat to simmer the contents therein takes place for about 45 minutes.

18. The method of claim 15, wherein returning the pot to the stovetop set to low heat to simmer the contents therein takes place for about 30 minutes.

19. The method of claim 15, wherein the onions are Vidalia onions, the maple syrup is grade A, dark amber maple syrup, and the olive oil is extra virgin olive oil.

20. The method of claim 15, wherein the method makes about 80 ounces of the consumable composition, and wherein the consumable composition comprises of between about 2 to about 6 onions, between about 1 to about 3 cups of water, between about ¼ to about ¾ cup maple syrup, between about 3 to about 9 ounces of tomato paste, between about ¼ to ¾ cup of olive oil, and between about ½ to about 1½ ounces of balsamic vinegar.
